(19) United States
(12) Patent Application Publication
(10) Pub. No.: US 2005/0195294 A1
(43) Pub. Date: Sep. 8, 2005

(54) Method of controlling digital photographing apparatus for adaptive image compositing, and digital photographing apparatus using the method

(75) Inventors: Hyun-gon Kim, Changwon-si (KR); Byoung-soo Kim, Changwon-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/023,229

(22) Filed: Dec. 27, 2004

(30) Foreign Application Priority Data
Mar. 6, 2004 (KR) 2004-15295

(51) Int. Cl. H04N 5/262

(52) U.S. Cl. 348/239

(57) ABSTRACT

Provided is a method of controlling a digital photographing apparatus having a shutter release button with a two-step structure. The method includes: selecting a sub-image according to a manipulation of a user; when the shutter release button is pressed to a first step according to the manipulation of the user, compositing the selected sub-image and an input image and displaying the composite image; and when the shutter release button is pressed to a second step according to the manipulation of the user, compositing the input image and the selected sub-image and then storing the composite image in a recording medium.

### BACKGROUND OF THE INVENTION

This application claims the priority of Korean Patent Application No. 2004-15295, filed on Mar. 6, 2004 in the Korean Intellectual Property Office, the disclosure of which are incorporated herein in its entirety by reference.

1. Field of the Invention

The present invention relates to a method of controlling a digital photographing apparatus and a digital photographing apparatus using the method, and more particularly, to a method of controlling a digital photographing apparatus having a shutter release button with a two-step structure, and a digital photographing apparatus using the method.

2. Description of the Related Art

According to typical digital photographing apparatuses, e.g., a digital photographing apparatus disclosed in U.S. Pat. No. 5,477,264, entitled “Electronic Imaging System using Removable Software-Enhanced Storage Device,” a user can reproduce an image stored in a recording medium after photographing to form a composite image with a sub-image.

However, an adaptive composition cannot be conveniently performed since the user has to composite a sub-image with the already photographed image.

### SUMMARY OF THE INVENTION

The present invention provides a method of controlling a digital photographing apparatus in which a user can conveniently perform adaptive image composition, and a digital photographing apparatus using the method.

According to an aspect of the present invention, there is provided a method of controlling a digital photographing apparatus having a shutter release button with a two-step structure. The method includes: selecting a sub-image according to a manipulation of a user; when the shutter release button is pressed to a first step according to the manipulation of the user, compositing the selected sub-image and an input image and displaying the composite image; and when the shutter release button is pressed to a second step according to the manipulation of the user, compositing the input image and the selected sub-image and then storing the composite image on a recording medium.

The method allows the user to composite the sub-image and the input image immediately before taking a photograph. Accordingly, the user can conveniently perform adaptive image composition.

According to another aspect of the present invention, there is provided a digital photographing apparatus using the method.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a digital camera, which is a digital photographing apparatus, according to an embodiment of the present invention;

FIG. 2 is a rear view of the digital camera of FIG. 1;

FIG. 3 is a block diagram of the digital camera of FIG. 1;

FIG. 4 is a view illustrating the structure of an optical system and a photoelectric converter of the digital camera of FIG. 1;

FIG. 5 is a flow chart illustrating a main operation of a digital signal processor included in the digital camera illustrated in FIG. 3;

FIG. 6 is a flow chart illustrating operations performed in a preview mode mentioned in FIG. 5;

FIG. 7 is a flow chart illustrating operations performed in a general photographing mode mentioned in FIG. 5;

FIG. 8 is a flow chart illustrating operations performed in a composite photographing mode mentioned in FIG. 5;

FIG. 9 is a view illustrating a screen displayed on a color liquid color display (LCD) panel through which a user may select a sub-image according to a setting mode operation mentioned in FIG. 5; and

FIG. 10 is a composite image displayed on the color LCD panel according to an operating of outputting image data mentioned in FIG. 6.

### DETAILED DESCRIPTION OF THE INVENTION

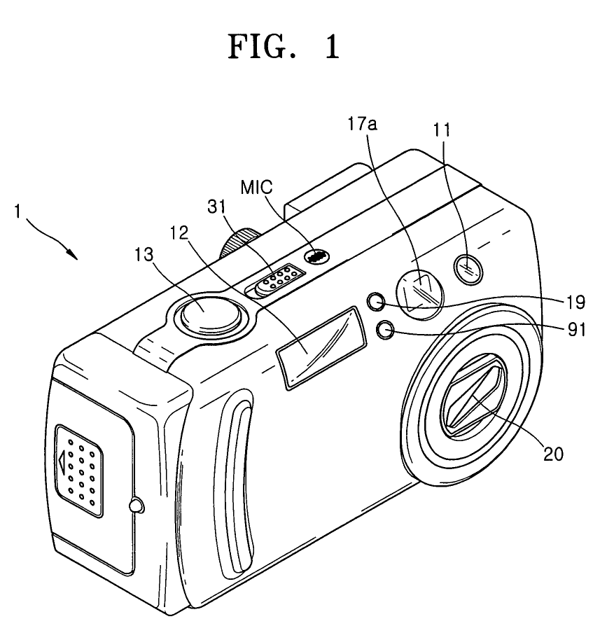

Referring to FIG. 1, a digital camera 1, which is a digital photographing apparatus according to an embodiment of the present invention, includes a self-timer lamp 11, a flash 12, a shutter release button 13, a view finder 17a, a flash-light amount sensor (FS) 19, a lens unit 20, and a remote receiver 91 on its front surface; and a microphone MIC, a shutter release button 13, and a power button 31 on its top surface.

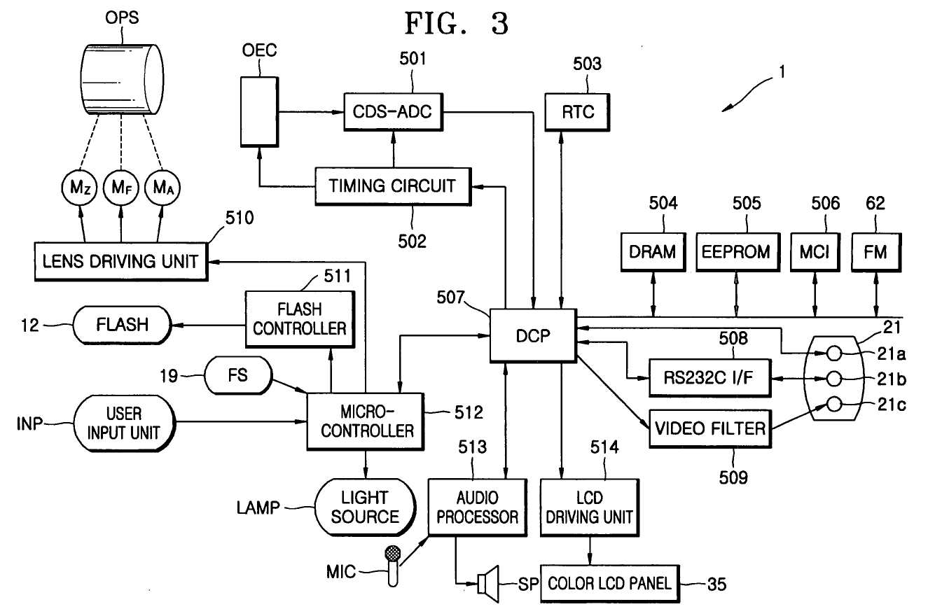

When in a self-timer mode, the self-timer lamp 11 operates for a predetermined amount of time after the shutter release button 13 is pressed until the capturing of an image begins. The FS 19 senses the amount of external light when the flash 12 operates, and inputs the sensed amount of external light into a digital camera processor (DCP) 507 (see FIG. 3) via a micro-controller 512 (see FIG. 3).

The remote receiver 91 receives a command signal, e.g., an infrared photographing command signal from a remote control (not shown), and inputs the photographing command signal to the DCP 507 via the micro-controller 512.

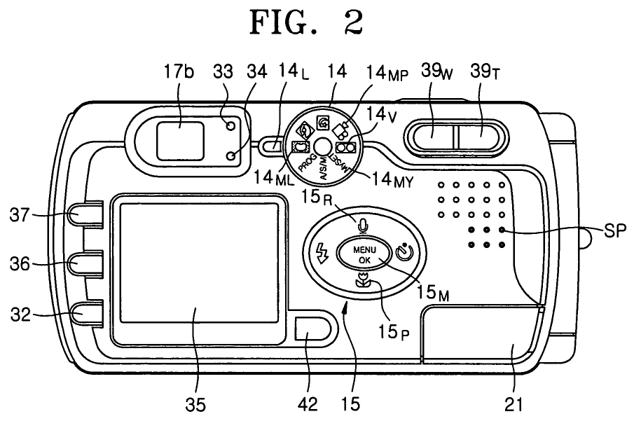

The shutter release button 13 has a two-step structure. That is, after a user presses a wide-angle zoom button 39_{W} (see FIG. 2) and a telephoto zoom button 39_{T} (see FIG. 2), if the shutter release button 13 is pressed to a first step, a first signal S1 output from the shutter release button 13 is activated, and if the shutter release button 13 is pressed to a second step, a second signal S2 output from the shutter release button 13 is activated.

Referring to FIG. 2, a mode dial 14, function buttons 15, a manual-focus/delete button 36, a manual-change/play button 37, a reproducing mode button 42, a speaker SP, a monitor button 32, an automatic-focus lamp 33, a view finder 17b, a flash standby lamp 34, a color liquid crystal display (LCD) panel 35, the wide-angle zoom button 39_{W}, the telephoto zoom button 39_{T}, and an external interface unit 21 are provided on the back of the digital camera 1.

The mode dial 14 is used to select one operating mode from a plurality of operating modes, for example, still image photographing modes including a composite photographing mode 14_{ML}, a program photographing mode, a portrait photographing mode, a night scene photographing mode, a manual photographing mode, a moving picture photographing mode 14_{MP}, a user setting mode 14_{MY}, and a recording mode 14_{V}.

The composite photographing mode 14_{ML} is an operating mode in which a photographing image is combined with a sub-image. The user setting mode 14_{MY} is used by a user to set photographing information needed for one of the still image photographing modes or the moving picture photographing mode. The recording mode 14_{V} is used to record only sound, for example, a voice of a user.

The function buttons 15 are used to perform specific functions of the digital camera 1 and acts as direction-movement buttons to move an activated cursor on a menu screen on the color LCD panel 35.

For example, automatic focusing for near objects is set if a user presses a macro/down-movement button 15_{P} when in one of the still image photographing modes or the moving picture photographing mode is set. If the user presses the macro/down-movement button 15_{P} while a menu for setting a condition of one of the operating modes is displayed by pressing a menu/select-confirm button 15_{M}, an activated cursor moves downwards.

If the user presses an audio-memo/up-movement button 15_{R}, up to 10 seconds of audio recording is performed immediately after a photographing operation is completed. If the user presses the audio-memo/up-movement button 15_{R} while a menu for setting a condition of one of the operating modes is displayed by pressing the menu/select-confirm button 15_{M}, an activated cursor moves upwards. If the user presses the menu/select-confirm button 15_{M} when the activated cursor is on a selection item, an operation corresponding to the selected item is performed.

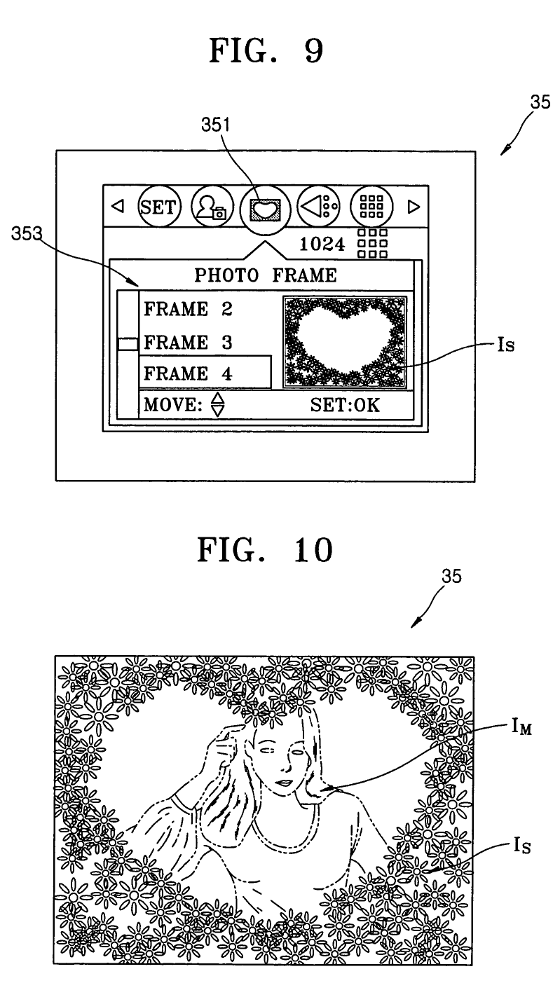

Therefore, when the user presses the menu/select-confirm button 15_{M} while in the composite photographing mode 14_{ML}, as illustrated in FIG. 2, a menu for selecting a sub-image is displayed (see FIG. 9). Accordingly, a selection confirming signal can be input by pressing the menu/select-confirm button 15_{M} after the user selects a desired sub-image by pressing the macro/down-movement button 15_{P} and the audio-memo/up-movement button 15_{R}.

The manual-focus/delete button 36 is used to manually focus or to delete an image in the photographing mode. The manual-change/play button 37 is used to manually change specific conditions and to perform functions such as stop and play in a reproducing mode. The reproducing mode button 42 is used when converting to the reproducing mode or a preview mode.

The monitor button 32 is used to control the operation of the color LCD panel 35. For example, if the user presses the monitor button 32 a first time in a photographing mode, an image of a subject and photographing information of the image is displayed on the color LCD panel 35, and if the monitor button 32 is pressed a second time, power supplied to the color LCD panel 35 is blocked. Also, if the user presses the monitor button 32 for a first time in a reproducing mode while an image file is being reproduced, photographing information of the image file that is being reproduced is displayed on the color LCD panel 35, and only the image file is displayed if the monitor button 32 is pressed a second time.

The automatic-focus lamp 33 operates when an image is well focused. The flash standby lamp 34 operates when the flash 12 (see FIG. 1) is in a standby mode. A mode indicating lamp 14_{L} indicates a selected mode of the mode dial 14.

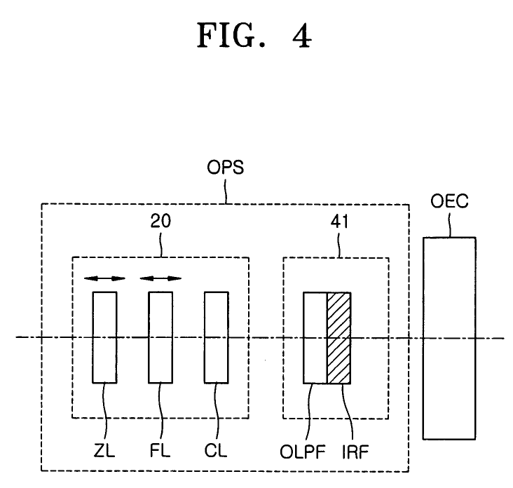

FIG. 3 is a block diagram of the digital camera 1 of FIG. 1. FIG. 4 is a view illustrating the structure of an optical system OPS and a photoelectric converter OEC of the digital camera of FIG. 1. Referring to FIGS. 1 through 4, the structure and operation of the digital camera 1 will now be described.

The optical system OPS includes the lens unit 20 and a filter unit 41 and optically processes light reflected from an object.

The lens unit 20 of the optical system OPS includes a zoom lens ZL, a focus lens FL, and a compensation lens CL.

If a user presses the wide-angle zoom button 39_{W} or the telephoto zoom button 39_{T}, which are included in a user input unit INP, a signal corresponding to the wide-angle zoom button 39_{W} or the telephoto zoom button 39_{T} is input to the micro-controller 512. Accordingly, as the micro-controller 512 controls a lens driving unit 510, a zoom motor M_{Z} operates, thereby controlling the zoom lens ZL. That is, if the wide-angle zoom button 39_{W} is pressed, a focal length of the zoom lens ZL is shortened, thereby increasing a view angle. Conversely, if the telephoto zoom button 39_{T} is pressed, a focal length of the zoom lens ZL is lengthened, thereby decreasing the view angle. Since the location of the focus lens FL is controlled while the location of the zoom lens ZL is fixed, the view angle is hardly affected by the location of the focus lens FL.

In an automatic focusing mode, a main controller (not shown) embedded in the DCP 507 controls the lens driving unit 510 via the micro-controller 512, and thus operates a focus motor M_{F}. Accordingly, the focus lens FL is moved by the focus motor M_{F}, and in this process, a number of steps of the location of the focus lens FL (e.g., a number of location steps of the focus motor M_{F}) are set at which an amount of high frequency in an image signal is increased the most.

The compensation lens CL of the lens unit 20 of the optical system OPS compensates for a refractive index, and thus does not operate independently. A motor M_{A} drives an aperture (not shown).

The filter unit 41 of the optical system OPS includes an optical low pass filter OLPF that removes high frequency optical noise components of incident light, and an infrared cut filter IRF that blocks infrared components of incident light.

The photoelectric converter OEC is included in a charge coupled device (CCD) or a complementary metal oxide semiconductor (CMOS) (not shown) and converts light from the optical system OPS into electrical analog signals. The DCP 507 controls a timing circuit 502 to control the operations of the photoelectric converter OEC and a correlation double sampler and analog-to-digital converter (CDS-ADC) 501. The CDS-ADC 501 processes the analog signals output from the photoelectric converter OEC, and converts them into digital signals after removing high frequency noise and altering the bandwidths of the analog signals.

A real-time clock (RTC) 503 provides time information to the DCP 507. The DCP 507 processes the digital signals output from the CDS-ADC 501, and generates digital image signals that are divided into brightness and chrominance signals.

A light emitting unit LAMP that is operated by the micro-controller 512 according to control signals output from the DCP 507 in which the main controller is embedded includes the self-timer lamp 11, the automatic-focus lamp 33, the mode indicating lamp 14_{L}, and the flash standby lamp 34. The user input unit INP includes the shutter release button 13, the mode dial 14, the function buttons 15, the monitor button 32, the manual-focus/delete button 36, the manual-change/play button 37, the wide-angle zoom button 39_{W}, and the telephoto zoom button 39_{T}.

The digital image signal transmitted from the DCP 507 is temporarily stored in a dynamic random access memory (DRAM) 504. Algorithms and setting data needed for the operation of the DCP 507 are stored in an electrically erasable and programmable read-only memory (EEPROM) 505. A memory card is inserted in a memory card interface (MCI) 506. Setting data needed for the operations of the DCP 507 is stored in a flash memory (FM) 62. The setting data includes data of sub-images used in the composite photographing. The memory card is removably installed in the MCI 506.

The digital image signals output from the DCP 507 are input to an LCD driving unit 514, and through this operation, an image is displayed on the color LCD panel 35.

The digital image signals output from the DCP 507 can be transmitted in a series communication via a universal serial bus (USB) connector 21a or an RS232C interface 508 and its connector 21b, or can be transmitted as video signals via a video filter 509 and a video outputting unit 21c.

An audio processor 513 outputs audio signals from the microphone MIC to the DCP 507 or the speaker SP, and outputs audio signals from the DCP 507 to the speaker SP.

The micro-controller 512 operates the flash 12 by controlling a flash controller 511 according to a signal output from the FS 19.

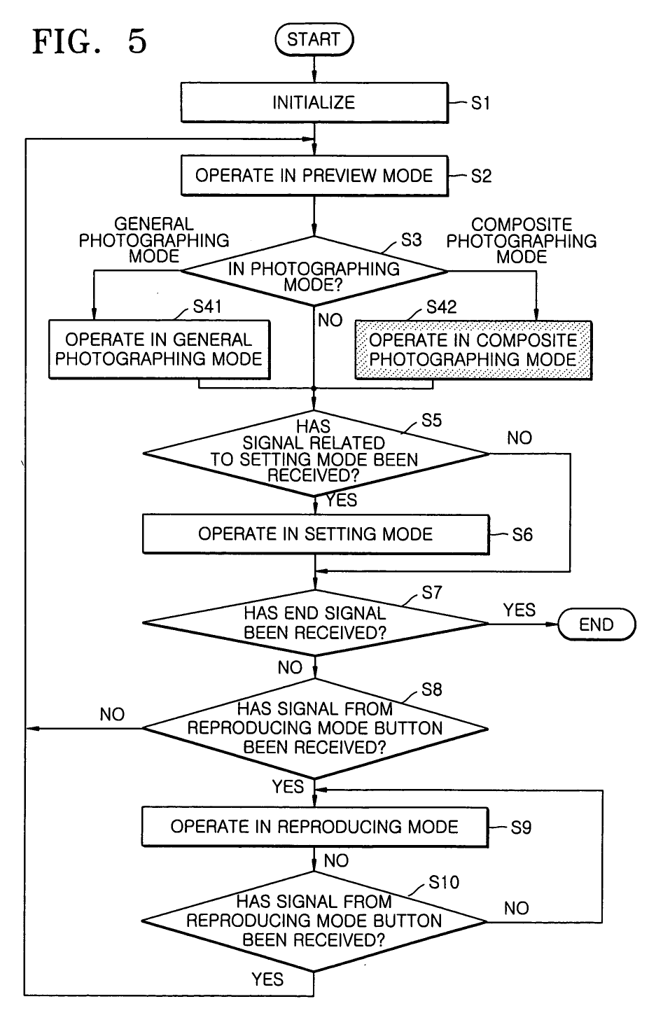

FIG. 5 is a flow chart illustrating the main operation of the DCP 507 illustrated in FIG. 3.

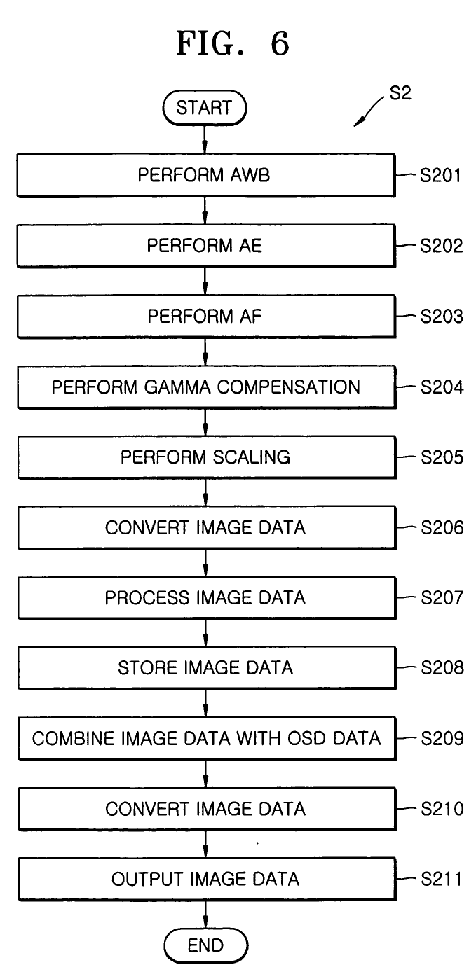

Referring to FIGS. 1 through 5, when power for operation is supplied to the digital camera 1, the DCP 507 performs initialization (S1). When operation S1 is performed, the DCP 507 enters a preview mode (S2). An input image is displayed on the color LCD panel 35 in the preview mode. Operations related to the preview mode will be described in more detail with reference to FIG. 6.

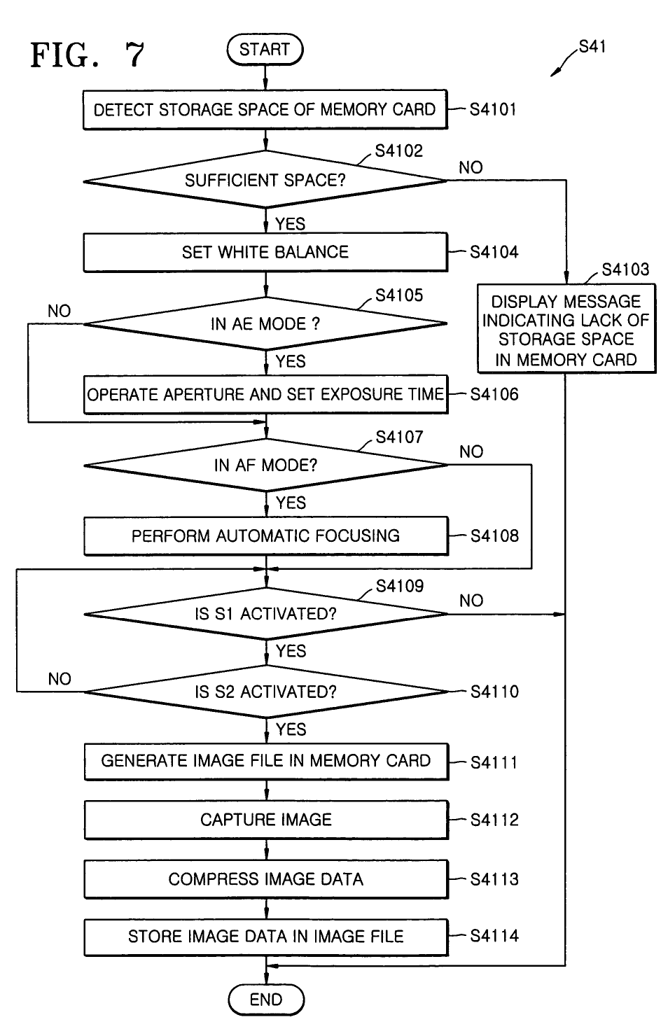

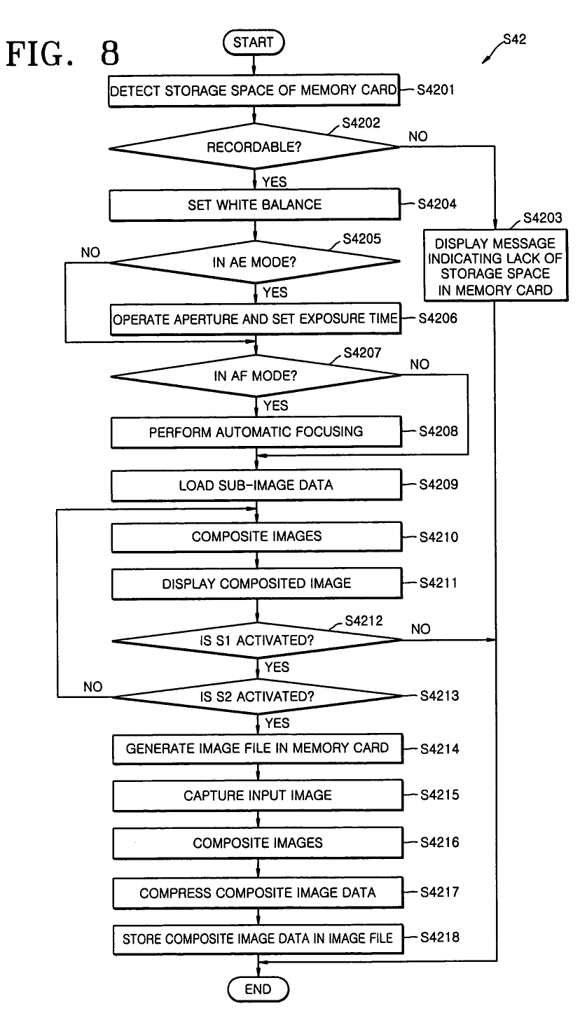

When the digital camera 1 is in a photographing mode in which the first signal S1 is activated, which is produced when a user presses the shutter release button 13 during the first step (S3), the DCP 507 operates in a general photographing mode (S41) or a composite photographing mode 14_{ML} (S42). The operations performed in the composite photographing mode 14_{ML} (S42) will be described later with reference to FIGS. 8 through 10, and the operations performed in the general photographing mode (S41) will be described later with reference to FIG. 7.

If signals related to a setting mode output from the user input unit INP is input to the DCP 507 (S5), the DCP 507 enters a setting mode, in which it sets operating conditions based on the input signals output from the user input unit INP (S6).

If an end signal is generated (S7), the procedure ends. If an end signal is not generated (S7), the DCP 507 continues to perform the following operations.

First, if a signal is generated by the reproducing mode button 42, which is inside the user input unit INP, the DCP 507 enters a reproducing mode (S9). In the reproducing mode, the DCP 507 sets operating conditions based on the input signals generated by the user input unit INP. If a signal is generated by the reproducing mode button again (S10), the operations S2 through S10 are repeated.

FIG. 6 is a flow chart illustrating the operations performed in the preview mode (S2) mentioned in FIG. 5.

Referring to FIGS. 1 through 3 and 6, first, the DCP 507 performs automatic white balance (AWB), and sets parameters related to the white balance (S201).

When in an automatic exposure (AE) mode (S202), the DCP 507 calculates the exposure by measuring incident luminance, and sets a shutter speed by driving the aperture driving motor M_{A} based on the calculated exposure (S203).

Then, the DCP 507 performs gamma compensation on input image data (S204), and scales the gamma compensated input image data so that the image fits in the display (S205).

Next, the DCP 507 converts the scaled input image data from red-green-blue data to brightness-chromaticity data (S206). The DCP 507 processes the input image data according to, for example, a resolution or a display location, and performs filtering (S207).

Afterwards, the DCP 507 temporarily stores the input image data in the DRAM 504 (see FIG. 3) (S208).

The DCP 507 combines the input image data temporarily stored in the DRAM 504 with on-screen display (OSD) data (S209). Then, the DCP 507 converts the combined image data from brightness-chromaticity data to red-green-blue data (S210), and outputs the image data to the LCD driving unit 514 (see FIG. 3) (S211).

FIG. 7 is a flow chart illustrating the operations performed in the general photographing mode (S41) mentioned in FIG. 5. This operation starts when the first signal S1 is activated. Here, the current location of the zoom lens ZL (see FIG. 4) is set in advance.

Referring to FIGS. 1 through 3 and 7, the DCP 507 detects the storage space of the memory card (S4101), and determines whether there is enough storage space to store digital image signals (S4102). If there is not enough storage space, the DCP 507 causes a message to be displayed on the LCD panel 35 indicating that there is a lack of storage space in the memory card (S4103) and ends the operation in the general photographing mode (S41 in FIG. 5). If storage is possible, the following operations are performed.

The DCP 507 sets a white balance according to currently set photographing conditions, and sets parameters related to the white balance (S4104).

If in an AE mode (S4105), the DCP 507 calculates exposure by measuring incident luminance, drives the aperture driving motor M_{A} according to the calculated exposure, and sets a shutter speed (S4106).

Then, if the digital camera 1 is in an AF mode (S4107), the DCP 507 performs automatic focusing and drives the focus lens FL (S4108).

The DCP 507 performs the following operations if the first signal S1 is activated (S4109).

First, the DCP 507 determines whether the second signal S2 is activated (S4110). If the second signal S2 is not activated, the user has not pressed the shutter release button 13 to the second step for photographing. Thus, the DCP 507 repeats sub-routines S4109 through S4110.

If the second signal S2 is activated, the user has pressed the shutter release button 13 to the second step for photographing, and thus the DCP 507 generates an image file in the memory card, which is the recording medium (S4111). Then, the DCP 507 captures an image (S4112). That is, the DCP 507 receives image data output from the CDS-ACD 501. The DCP 507 compresses the image data (S4113), and then stores the compressed image data in the image file (S4114).

FIG. 8 is a flow chart illustrating the operations performed in the composite photographing mode 14_{ML} (S42) mentioned in FIG. 5, and FIG. 9 is a view illustrating a screen displayed on the color LCD panel 35 (see FIG. 2) through which a user selects a sub-image I_{S} according to the mode set operation (S6) mentioned in FIG. 5. FIG. 10 is a composite image displayed on the color LCD panel 35 according to the outputting of the image data S211 mentioned in FIG. 6.

First, the process of setting the composite photographing mode 14_{ML} S42 in the mode set operation S6 is as follows. As described above, when a user presses the menu/select-confirm button 15_{M} (see FIG. 2) while the composite photographing mode 14_{ML} (see FIG. 2) is set by the mode dial 14 (see FIG. 2), a menu for selecting a sub-image is displayed on the color LCD panel 35. In more detail, referring to FIG. 9, an icon 351 displayed on the color LCD panel 35 in the composite photographing mode 14_{ML} is activated and sub-items 535 of the sub-image are displayed. After the user selects a desired sub-image (a sub-image I_{S} of “FRAME 4” in FIG. 9) by manipulating the macro/down-movement button 15_{P} and the audio-memo/up-movement button 15_{R}, a selection confirm signal can be input by pressing the menu/select-confirm button 15_{M}.

Referring to FIGS. 1 through 3 and FIGS. 8 through 10, the operations performed in the composite photographing mode 14_{ML} (S42) mentioned in FIG. 5 will now be described. This operation starts when the first signal S1 is activated. Here, the current location of the zoom lens ZL (see FIG. 4) is set in advance.

The DCP 507 detects storage space of the memory card (S4201), and determines whether there is enough storage space to store digital image signals (S4202). If there is not enough storage space, the DCP 507 indicates that there is a lack of storage space in the memory card and ends the operation in the general photographing mode (S41 in FIG. 5). If storage space is sufficient, the following operations are performed.

The DCP 507 sets a white balance according to currently set photographing conditions, and sets parameters related to the white balance (S4204).

If the digital camera 1 is in an AE mode (S4205), the DCP 507 calculates exposure by measuring incident luminance, drives the aperture driving motor M_{A} according to the calculated exposure, and sets a shutter speed (S4206).

Then, if the digital camera 1 is in an AF mode (S4207), the DCP 507 performs automatic focusing and drives the focus lens FL (S4208).

The DCP 507 reads, from the FM 62 (see FIG. 3), data of the sub-image (sub-image I_{S} of “FRAME 4” in FIG. 9) selected in the process of setting the composite photographing mode 14_{ML} and loads the sub-image (S4209). An input image I_{M} (see FIG. 10), which is temporarily stored in the DRAM 504 is composited with the sub-image I_{S} (see FIG. 10) (S4210), and the composite image is displayed on the color LCD panel 35 (S4211). Accordingly, the user may adjust the input image I_{M} while pressing the shutter release button 13 to the first step so that the input image I_{M} fits appropriately with the sub-image I_{S}. Thus, the user may conveniently perform adaptive image composition.

Next, the DCP 507 performs the following operations if the first signal S1 is activated (S4212).

First, the DCP 507 determines whether the second signal S2 is activated (S4213). If the second signal S2 is not activated, the user has not pressed the shutter release button 13 to the second step for photographing. Thus, the DCP 507 repeats sub-routines S4210 through S4213.

If the second signal S2 is activated, the user has pressed the shutter release button 13 to the second step for photographing, and thus the DCP 507 generates an image file in the memory card, which is the recording medium (S4214). Then, the DCP 507 captures an image (S4215). That is, the DCP 507 receives image data output from the CDS-ACD 501.

Then, the DCP 507 combines the captured input image, which is the main image I_{M}, and the sub-image I_{S} (S4216) to create a composite image. The DCP 507 compresses the composite image data (S4217), and then stores the compressed composite image data in the image file (S4218).

As described above, according to a method of controlling a digital photographing apparatus and a digital photographing apparatus using the method, a user may instantly composite a sub-image with an input image right before photographing. Accordingly, the user may conveniently produce an adaptive composition image.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of creating a composite image on a digital camera, the method comprising:
receiving input image data from an optical system of the digital camera, the input image data representing a subject to be photographed by the digital camera;
retrieving, from a memory of the digital camera, a sub-image, the sub-image having been selected by a user of the digital camera;
when a shutter release button of the camera is pressed to a first step by the user, combining the selected sub-image and the input image data;
displaying an image representing the combined sub-image and input image data on a display of the digital camera;
when the shutter release button is pressed to a second step by the user, combining the input image data and the selected sub-image into a composite image; and
storing the composite image on a recording medium.

2. The method of claim 1, further comprising performing automatic focusing on the imput image prior to the combining step.

3. The method of claim 1, further comprising displaying, on the display, a plurality of sub-images from which the user may choose.

4. The method of claim 1, wherein the storing step comprises generating an image file in the recording medium.

5. The method of claim 1, further comprising, while the shutter release button is pressed to the first step, receiving a change in the input image data based on an adjustment made by the user.

6. The method of claim 1, wherein the sub-image is a decorative border that frames an image being photographed.

7. The method of claim 1, further comprising:
displaying, on the display, a plurality of sub-images from which the user may choose, each of the plurality of sub-images representing a decorative border that frames an image that the user is photographing;
while the shutter release button is pressed to the first step, receiving an adjustment from the user; and
in response to the adjustment, repositioning the image that the user is photographing so that it fits more centrally within the decorative border.

8. The method of claim 1, further comprising:
determining whether the digital camera is in auto-exposure mode; and
if the digital camera is determined to be in auto-exposure mode, adjust an aperture of the digital camera and set the exposure time of the subject.

9. The method of claim 1, further comprising:
determining whether there is sufficient storage space available on the recording medium to store further images; and
if sufficient storage space is determined not to be available, displaying a message indicating a lack of storage space on the display of the digital camera.

10. The method of claim 1, further comprising compressing the composite image prior to the storing step.

11. A digital imaging apparatus, the apparatus comprising:
an optical system that receives light from a subject to be photographed by the apparatus;
a digital processor that receives signals representing the light received by the optical system and converts the signals into a primary image;
a display screen that displays a plurality of available sub-images;
a selection mechanism a user manipulates to select a sub-image from the plurality of displayed sub-images;
an activation mechanism having a first position and a second position,
wherein when the user puts the activation mechanism into the first position, the digital processor retrieves the selected sub-image, combines it with the primary image, and displays the combination on the display screen;
and wherein when the user puts the activation mechanism into the second position, the digital processor retrieves the selected sub-image, combines it with the primary image to create a composite image, and stores the composite image into a recording medium.

12. The apparatus of claim 11, further comprising a mode selection mechanism that allows the user to put the apparatus in at least a general photographing mode and a composite photographing mode, wherein combining steps are performed only if the user has put the apparatus in the composite photographing mode using the mode selection mechanism.

13. The apparatus of claim 11, further comprising a photoelectric converter that converts light received by the optical system into electrical analog signals.

14. The apparatus of claim 13, further comprising a correlation douple sampler and analog-to-digital converter that process the analog signals output from the photoelectric converter, removes high frequency noise from the signals, alters the bandwidth of the signals, and converts the signals into digital signals, which are processed by the digital processor.

15. The apparatus of claim 11, wherein when the activation mechanism is in the first position, a first signal is generated, and when the activation mechanism is in the second position, a second signal is generated.

16. The apparatus of claim 11, wherein prior to storing the composite image in the recording medium, the digital processor compresses the image.

17. A digital camera comprising:
means for selecting a sub-image from a plurality of sub-images displayed on a display screen of the digital camera;
means for obtaining a primary image of a subject to be photographed;
means for creating a composite image of the selected sub-image and the primary image; and
means for indicating whether the composite image is to be stored in a memory of the digital camera.

18. The digital camera of claim 17, wherein the selecting means is a menu selection button.

19. The digital camera of claim 17, wherein the indicating means is a two-step activation button, wherein the user indicates that the composite image is to be stored in the memory by pressing the button to the second step.

20. The digital camera of claim 17, wherein the obtaining means comprises an optical system and a photoelectric converter, wherein the optical system receives light from the subject, and the photoelectric converter converts the light into analog electrical signals.
